(19) United States
(12) Patent Application Publication
(10) Pub. No.: US 2015/0222680 A1
(43) Pub. Date: Aug. 6, 2015

(54) LOCAL NETWORK MEDIA SHARING

(71) Applicant: Ford Global Technologies, LLC, Dearborn, MI (US)

(72) Inventor: Joey Ray Grover, Madison Heights, MI (US)

(73) Assignee: Ford Global Technologies, LLC, Dearborn, MI (US)

(21) Appl. No.: 14/172,188

(22) Filed: Feb. 4, 2014

(51) Int. Cl. H04L 29/06; G06F 17/30

(52) U.S. Cl. CPC H04L 65/60; H04L 65/403; G06F 17/30053

(57) ABSTRACT

A server may provide media output to a vehicle and be configured to compile a combined media content list including metadata describing media content stored by network devices identified by the server; map an instance of media content from a shared playlist maintained by the server to one of the network devices storing the media content according to the content list; and play the instance of media content through the media output.

### TECHNICAL FIELD

The present disclosure generally relates to media devices, and more particularly, to local network media sharing.

### BACKGROUND

With the advent of mobile devices with capacity to store libraries of media content, users may carry significant amounts of content with them. To play the carried media content to an audience, a user may connect his or her device to a stereo or playback system, and may select songs or other audio content to be played. If another user wishes to play his own content, then that user may be required to disconnect the first user's audio device, and connect his own device to the playback system.

### SUMMARY

In a first illustrative embodiment, a computer-implemented method includes compiling, by a server device, a combined media content list including metadata describing media content stored by network devices connected to the server device; mapping, according to the content list, an instance of media content from a shared playlist maintained by the server device to one of the network devices storing the media content; and playing the instance of media content through a server device media output to a playback system.

In a second illustrative embodiment, a system includes a vehicle infotainment system; and a server configured to compile a combined media content list of media stored by nomadic network devices wirelessly connected to the server via a local ad-hoc network; retrieve a media content instance identified on a server-maintained shared playlist from one of the network devices identified by the content list as storing the media; and provide the media content instance through a media output for infotainment system playback.

In a third illustrative embodiment, a non-transitory computer readable medium includes instructions configured to cause a server to compile a combined media content list of media stored by nomadic network devices wirelessly connected to the server via a local ad-hoc network; retrieve a media content instance identified on a server-maintained shared playlist from one of the network devices identified by the content list as storing the media; and provide the media content instance through a media output to a playback system.

### BRIEF DESCRIPTION OF THE DRAWINGS

FIG. 1 is an exemplary block topology of a vehicle infotainment system implementing a user-interactive vehicle based computing system;

FIG. 2 is an exemplary block topology of an example system for integrating one or more nomadic devices with the vehicle based computing system;

FIG. 3A is an illustrative example of a portion of a vehicle configured for playing media content from nomadic devices via the vehicle based computing system;

FIG. 3B is an alternate illustrative example of a portion of a vehicle configured for playing media content from nomadic devices via vehicle based computing system;

FIG. 4 is an illustrative example of a flow diagram of a plurality of nomadic devices compiling a combined registered media content list and playing media content through the vehicle based computing system;

FIG. 5 illustrates an exemplary user interface for utilizing a playlist for organizing media content to be played by the server nomadic device;

FIG. 6 illustrates an exemplary process for compiling a combined registered media content list of all the media content stored by the nomadic devices; and

FIG. 7 illustrates an exemplary process for playing media content by the server nomadic device through the vehicle based computing system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

In a setting with a single media playback system and multiple users, such as a vehicle having an integrated infotainment system, it may be difficult for the multiple users to control the media content being provided by the system. One potential approach for sharing control of the media playback system is to allow the users to change whose media device is connected to the media playback system. For example, one user may plug in his mobile phone in place of another user's device so that he may play back content stored on his mobile phone. Another potential approach is to allow the users to pass around the device currently connected to the media playback system. However, these approaches may be difficult or dangerous to perform in the vehicle environment, or may cause undesirable noise during device connection and disconnection.

An improved media playback system may include an ad-hoc local area network of devices, with one of the devices being connected to the media playback system. The network of devices may register with one another, and may compile a combined registered media list of all the media that the devices each store locally. The one of the devices connected to the media playback system may be used by any of the registered network devices to play any of the media content from the combined registered media list through the media playback system.

For example, one of the devices connected to the media playback system may be designated a server device, and may provide its address to the other devices in the vehicle so they may register with the server device. The server device may be further configured to query itself and the other network devices for listings of media content stored by the registered devices. The server device may compile the registered media list, and may share the media list with the other connected devices. Each of the connected devices (including the server device) may then request specific media files to be played by manipulating a shared system playlist maintained by the server device. To play media content listed by the playlist, the server device may identify from the registered media list which networked device stores the requested media, and request the media content from the storing device. The identified storing device may then stream the media to the server device, and the server device may play the received media content back through its connection to the media playback system.

By using the ad-hoc network of devices, multiple users within the vehicle may be able to share the capabilities of the media playback system, without having to disconnect and reconnect devices to the media playback system, and without passing devices around in the vehicle cabin. Moreover, as the shared media content may be hosted by the connected devices, the local network may be able to share media among the devices without requiring a connection to an outside network such as the Internet.

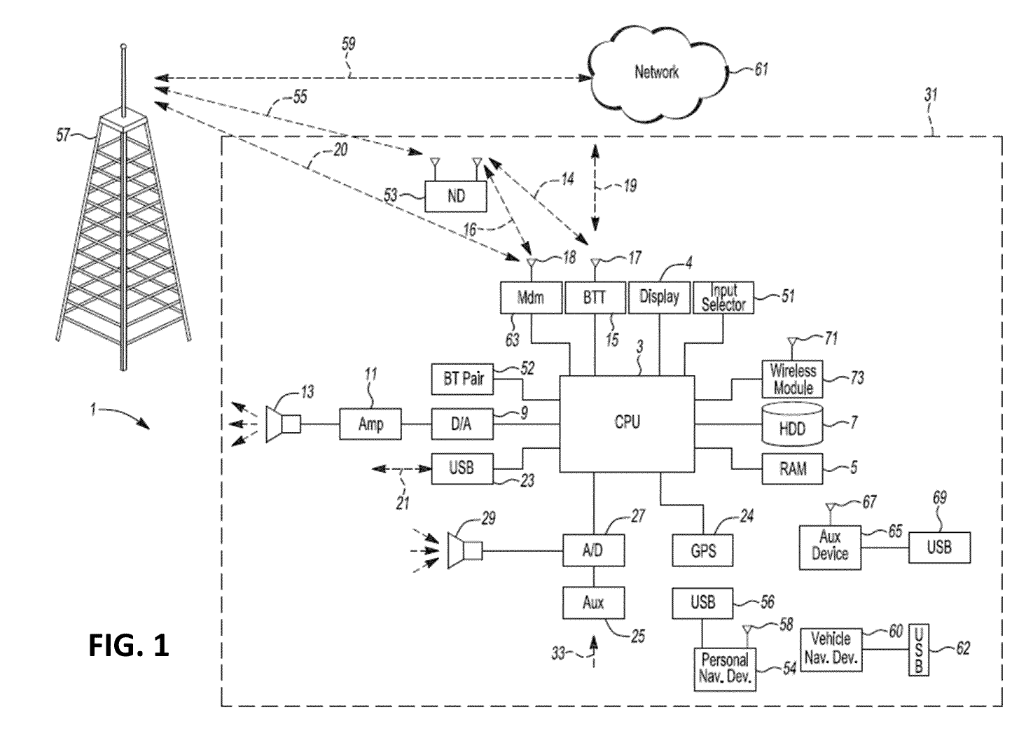

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

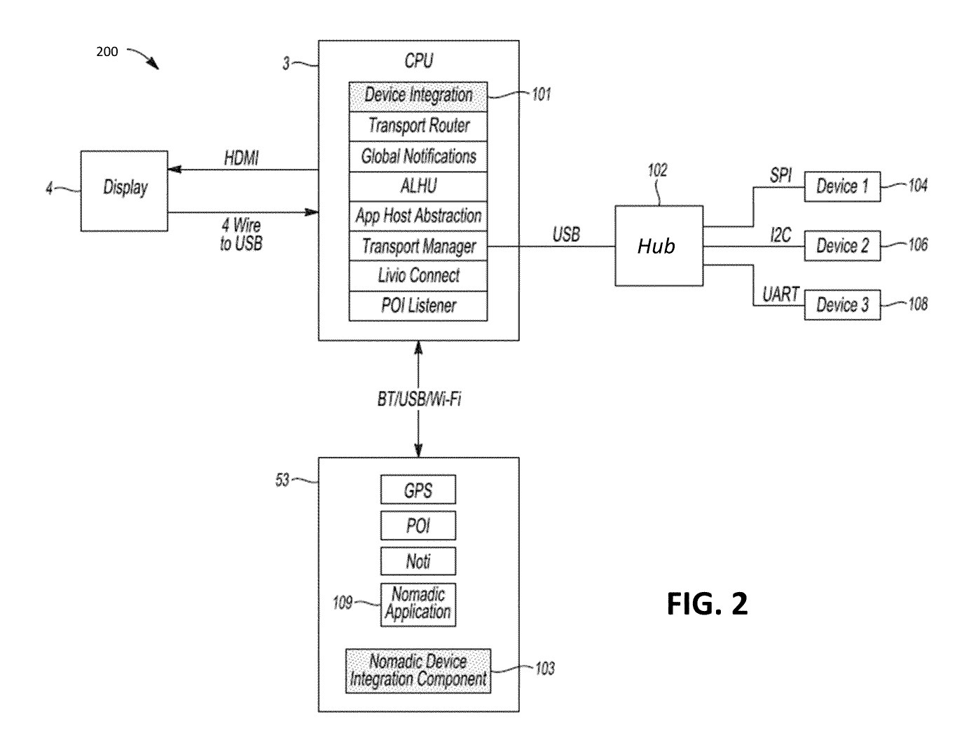

FIG. 2 is an exemplary block topology of a system 200 for integrating one or more connected devices with the vehicle based computing system 1 (VCS). To facilitate the integration, the CPU 3 may include a device integration framework 101 configured to provide various services to the connected devices. These services may include transport routing of messages between the connected devices and the CPU 3, global notification services to allow connected devices to provide alerts to the user, application launch and management facilities to allow for unified access to applications executed by the CPU 3 and those executed by the connected devices, and point of interest location and management services for various possible vehicle 31 destinations.

As mentioned above, the CPU 3 of the VCS 1 may be configured to interface with one or more nomadic devices 53 of various types. The nomadic device 53 may further include a device integration client component 103 to allow the nomadic device 53 to take advantage of the services provided by the device integration framework 101. Applications executed by the nomadic device 53 may accordingly utilize the device integration client component 103 to interact with the CPU 3 via the device integration framework 101. As one example, a music player application on the nomadic device 53 may interact with the CPU 3 to provide streaming music through the speaker 13 or stereo system output of the VCS 1. As another example, a navigation application on the nomadic device 53 may interact with the CPU 3 to provide turn-by-turn directions for display on the screen 4 of the VCS 1.

The multiport connector hub 102 may be used to interface between the CPU 3 and additional types of connected devices other than the nomadic devices 53. The multiport connector hub 102 may communicate with the CPU 3 over various buses and protocols, such as via USB, and may further communicate with the connected devices using various other connection buses and protocols, such as Serial Peripheral Interface Bus (SPI), Inter-integrated circuit (I2C), and/or Universal Asynchronous Receiver/Transmitter (UART). The multiport connector hub 102 may further perform communication protocol translation and interworking services between the protocols used by the connected devices and the protocol used between the multiport connector hub 102 and the CPU 3. The connected devices may include, as some non-limiting examples, a radar detector 104, a global position receiver device 106, and a storage device 108.

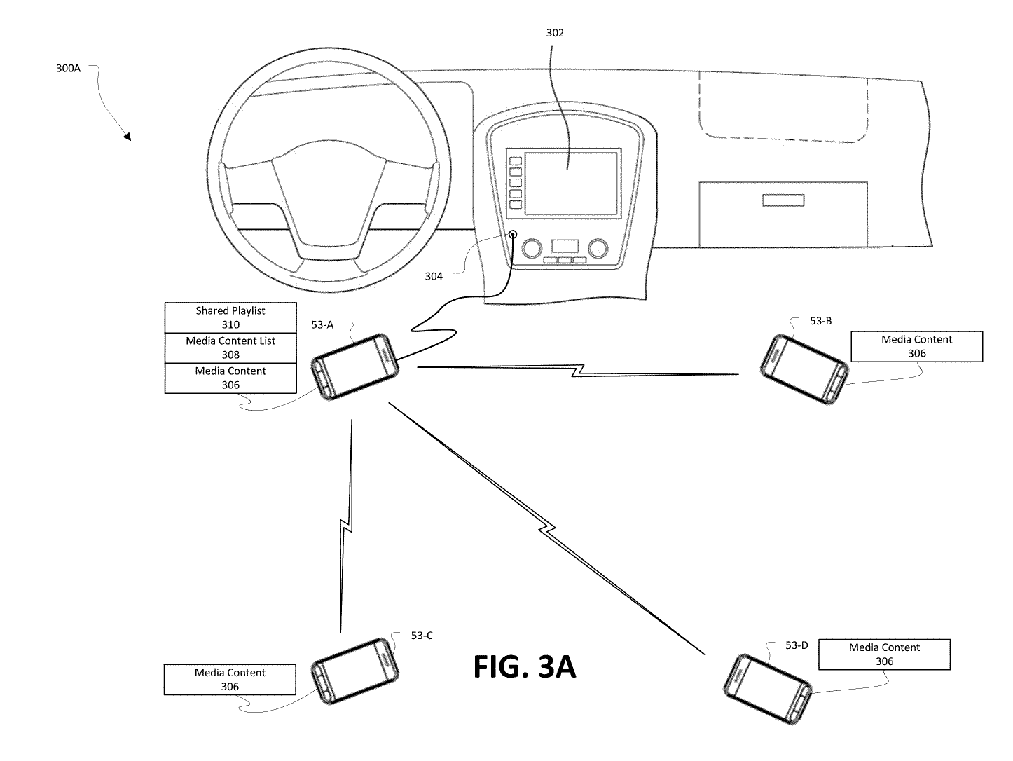

FIG. 3A is an illustrative example 300A of a portion of a vehicle 31 configured for playing media content 306 from nomadic devices 53 via the VCS 1. As illustrated, the vehicle 31 include a head unit 302 mounted in a relatively centralized control area between the driver and front passenger seats. The vehicle 31 further includes a plurality of networked nomadic devices 53-A through 53-D (collectively 53). The nomadic device 53-A is additionally connected to a media input 304 to the VCS 1, and may accordingly be referred to as the server nomadic device 53. It should be noted that this configuration is merely exemplary, and more or fewer nomadic devices 53, as well as other vehicle 31 and VCS 1 layouts may be utilized as well.

Each nomadic device 53 may store zero or more instances of media content 306 on one or more memories of the nomadic device 53. Media content 306 may include, for example, one or more of audio media content 306 and video media content 306. Audio media content 306 may include downloaded content such as music, as well as content recorded by the nomadic device 53, such as live performances or recorded calls or other communications. Video media content 306 may include downloaded content such as television, movies, and commercials, as well as video content recorded by the nomadic device 53 such as home movies. The media content 306 may further include or otherwise be associated with metadata media content 306, such as name, artist, title, track number, duration, rating, date recorded and date downloaded, as some non-limiting examples.

The server nomadic device 53 may be configured to compile and maintain a combined registered media content list 308 of all the media content 306 that the devices 53 each store locally. The registered media content list 308 may include, for example, a collection of the metadata media content 306 from the nomadic devices 53, as well as indications of which of the nomadic devices 53 store which instances of media content 306. Notably, to build the media content list 308 the server nomadic device 53 may utilize the metadata, so that it would not be required to download the full instances of media content 306 from the other nomadic devices 53.

The system may further provide for the use of playlists 310 for playback by the server nomadic device 53-A. A playlist 310 may include, for example, an ordered collection of instances of media content 306. The server nomadic device 53 may be further configured to maintain a shared playlist 310 that may be viewable and updateable by multiple of the nomadic devices 53.

FIG. 3B is an alternate illustrative example 300B of a portion of a vehicle 31 configured for playing media content 306 from nomadic devices 53 via the VCS 1. In the alternate example 300B, the head unit 302 of the VCS 1 itself may perform the role of the server nomadic device 53-A and may be included in the local network allowing for sharing of the media playback functions. In such an example, the head unit 302 may operate as one of the devices 53, and may perform functions such as providing instances of media content 306, playing media content 306 through the VCS 1 (e.g., without requiring use of media input 304, utilizing an internal media input 304, etc.), and displaying and/or updating of the playlist 310. As one possibility, the head unit 302 may make available instances of media content 306 stored by a hard drive or other storage device of the VCS 1 for use by the nomadic devices 53. As yet a further possibility, the head unit 302 of the VCS 1 may implement only a subset of the features of the nomadic devices 53, such as, for example, providing the playlist presentation 502 or only information regarding the currently played instance of media content 306 on a display of the head unit 302 for display purposes only, without offering editing capabilities to the shared playlist 310.

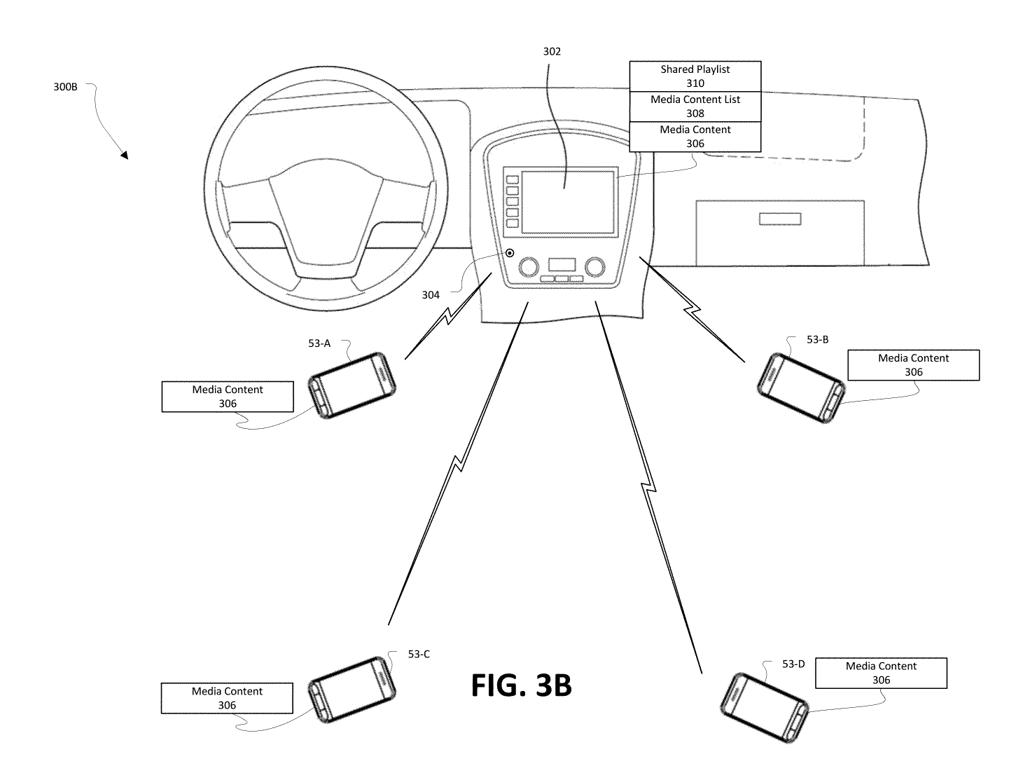

FIG. 4 is an illustrative example of a flow diagram 400 of a plurality of nomadic devices 53 compiling a combined registered media content list 308 and playing media content 306 through the VCS 1. The flow diagram 400 may be performed for example, by way of the example 300A portion of a vehicle 31 configured for playing media content from nomadic devices 53 via the VCS 1 described above with respect to FIG. 3A. It should again be noted that this configuration is merely exemplary, and more or fewer nomadic devices 53 may be utilized.

The nomadic devices 53 may be locally networked to together to allow for sharing of the media playback functions of the VCS 1 among the nomadic devices 53. To facilitate the local networking, one of the nomadic devices 53 may be configured to provide its address to the other nomadic devices 53 to allow the other devices 53 to connect to the address. As one possibility, the server nomadic device 53-A may be configured to display its address on the device display in a user-readable form (such as in the form of a numerically-represented Internet Protocol (IP) address), and the users of each of the other nomadic devices 53 (e.g., devices 53-B and 53-C as illustrated in the flow diagram 400) may enter the displayed IP address into their devices 53-B and 53-C to facilitate the connection. As another possibility, server nomadic device 53-A may be configured to display its address encoded in a bar code or other device-recognizable format (e.g., as a quick response (QR) matrix two-dimensional bar code, as another type or dimension of bar code, as another type of symbolic representation, in an numeric or alphanumeric form, etc.), such that the other nomadic devices 53-B and 53-C may capture an image of the display of the server nomadic device 53-A and decode the image to retrieve the server address. As yet a further possibility, the server nomadic device 53-A may provide an audio encoding of the server address (e.g., via the sound functions of the VCS 1, via the audio media playback functions of the nomadic device 53-A, etc.), such that the other nomadic devices 53-B and 53-C may capture the audio, and decode the audio to retrieve the server address. The server address may be acquired using other technologies as well. For instance, the nomadic devices 53-B and 53-C may utilize a local low energy protocol for sending and receiving short pieces of data (such as BLUETOOTH Low Energy (BLE)) to read stored server address information made available by the server nomadic device 53-A. Or, the nomadic devices 53-B and 53-C may utilize network service discovery to perform a local network lookup for an advertised media playback service registered by the server nomadic device 53-A. Regardless of approach, using the address the nomadic devices 53-B and 53-C may accordingly send a registration message 402 to the server nomadic device 53-A to register with the server nomadic device 53-A.

The network of nomadic devices 53 may be further configured to compile the combined registered media content list 308 of all the media content 306 that the devices 53 each store locally. As one possibility, the server nomadic device 53 may send a request 404 to each of the connected nomadic devices 53 querying the receiving connected nomadic devices 53 for a listing of their instances of media content 306. Each nomadic device 53 being queried may be configured to compile and return a response 406 including a listing of the instances of media content 306 hosted by the respective device 53. The listing may, for example, include the metadata for each of the instances of media content 306 hosted or stored by the responding nomadic device 53. As one possibility, each of the other nomadic devices 53-B and 53-C may provide the listings to the server nomadic device 53-A as a set of name/value pairs specifying the metadata properties of the instances of media content 306 stored by the nomadic device 53.

The server nomadic device 53-A may receive each of the responses 406, and compile the combined registered media content list 308 based on the listings included in the responses 406. The server nomadic device 53-A may also query its own storage of media content 306, and add those listings to the combined registered media content list 308 as well. When compiled, the registered media content list 308 may include, for example, at least a subset of the metadata information received from the nomadic devices 53. The registered media content list 308 may also include other content as well, such as unique identifiers of each of the instances of media content 306 (e.g., arbitrarily defined by the server nomadic device 53-A, defined according to a database of media content such as the compact disk data base (CDDB) maintained by Gracenote Inc. subsidiary of Sony Corporation of America, etc.). The registered media content list 308 may further include indications of which instances of media content 306 are stored by which of the nomadic devices 53 (e.g., indicated by IP addresses of the nomadic devices 53 or another network-unique identifier of the nomadic devices 53).

The server nomadic device 53-A may be further configured to share or otherwise make the combined registered media content list 308 available to the other connected nomadic devices 53 (and/or to the server nomadic device 53-A itself), to allow any of the nomadic devices 53 to request media content 306 for playback. By requesting media instances 306 from the registered media content list 308, each of the connected nomadic devices 53 (including the server nomadic devices 53) may be able to utilize the server nomadic device 53-A to share the media playback functionality of the VCS 1.

The nomadic device 53-B may send a request 408 for the registered media content list 308 to the nomadic device 53-A e.g., while requesting playback of a particular instance of media content 306, while adding media content 306 to the playlist 310, etc.). The nomadic device 53-A may return 410 to the nomadic device 53-B the registered media content list 308

As one possibility, the nomadic device 53-B may further send a request 412 to the server nomadic device 53-A requesting playback of an instance of media content 306 included in the registered media content list 308. As another possibility, the nomadic device 53-B may send a request for addition of the instance of media content 306 to the playlist 310, and may then request playback 412 of the playlist 310 or of an instance of media content 306 added to the playlist 310. The nomadic device 53-B may specify the instance of media content 306 in the request 412 to the server nomadic device 53-A in various ways, such as according to metadata information provided in the registered media content list 308, according to an index into the registered media content list 308, or according to a unique identifier included in the registered media content list 308 associated with the requested instance of media content 306.

The server nomadic device 53-A may be configured to receive the request 412, and identify the requested instance of media content 306. Using the registered media content list 308, the server nomadic device 53-A may be configured to identify which of the nomadic devices 53 is storing the requested instance of media content 306 (e.g., as illustrated the nomadic device 53-C), and, based on the identification, send a request 414 to the storing nomadic device 53-C requesting the instance of media content 306.

The storing nomadic device 53-C may be configured to receive the request 414, prepare the requested instance of media content 306 for streaming, and provide the requested media content instance 306 to the server nomadic device 53-A. Preparation of the media content instance 306 for streaming may include, for example, locating the media content 306 in storage, loading the media content 306 from storage, and, in some cases, encoding or transcoding the media content 306 to a format suitable for being provided to the nomadic device 53-A. The server nomadic device 53-A may be configured to receive 416 the media content 306 being provided for playback responsive to the request 414.

The server nomadic device 53-A may be configured to play 418 the received media content 306. For example, the server nomadic device 53-A may be configured to process the media content 306 into an audio signal, and provide the audio signal from the server nomadic device 53-A to the media input 304 of the VCS 1. Additionally or alternately, the server nomadic device 53-A may be configured to process the media content 306 into a video signal, and provide the video signal from the server nomadic device 53-A to the media input 304 of the VCS 1. Notably, in such examples the VCS 1 may not be required to be in communication with the network of nomadic devices 53 apart from the media input 304, and may also not be required to perform any signaling with the nomadic devices 53. Rather, the VCS 1 may instead simply play back whatever media content is provided to the VCS 1 via the media input 304. As some example, the VCS 1 may be configured to play back an audio signal provided to the VCS 1 using a sound system of the VCS 1, and play back a video signal provided to the VCS 1 using a display of the head unit 302 or one or more other display units of the VCS 1, such as headrest or other vehicle 31 video display units visible from the second or third vehicle 31 rows.

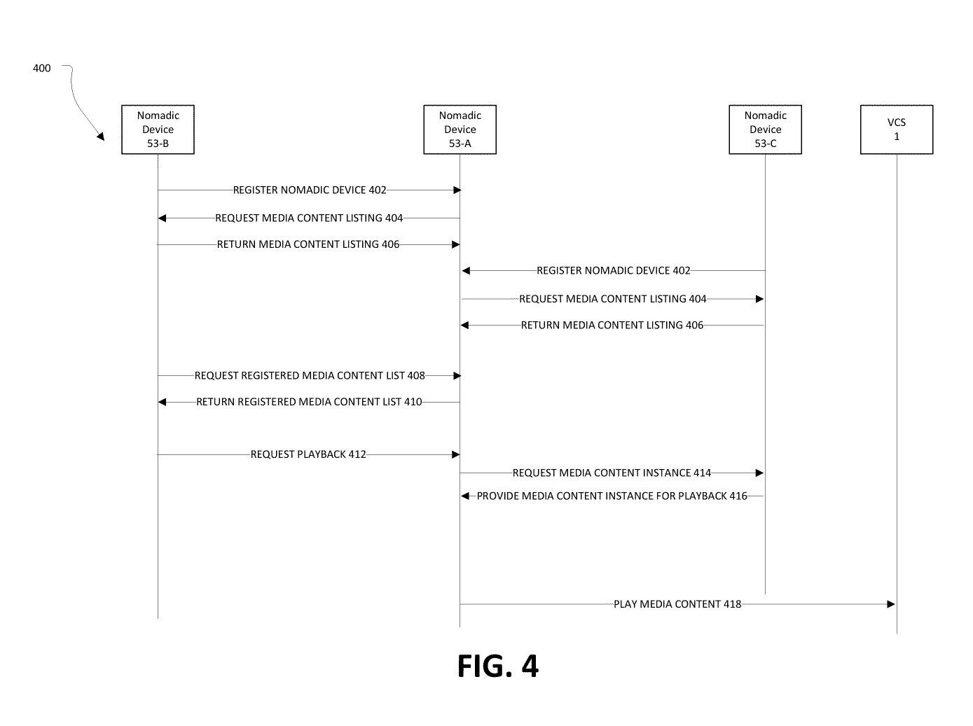

FIG. 5 illustrates an exemplary user interface 500 for utilizing a playlist 310 for organizing media content 306 to be played by the server nomadic device 53-A. The user interface 500 may be presented, for example, on a display screen of one of the nomadic devices 53, and may include a playlist presentation 502 of the instances of media content 306 of the shared playlist 310. The user interface 500 may further provide an indication 504 that the user interface 500 displays a playlist presentation 502, as well as an indication 506 of the instance of media content 306 currently being played by the server nomadic device 53-A. The user interface 500 may also include additional controls, such as an add element 508 configured to facilitate the addition of instances of media content 306 to the playlist 310, a remove element 510 configured to facilitate the removal of instances of media content 306 from the playlist 310, a move up element 512 and a move down element 514 configured to reorder the instances of media content 306 within the playlist 310, and a refresh element 516 configured to facilitate refresh of the registered media content list 308 for media content 306 made available by the device 53 displaying the user interface 500.

More specifically, the playlist presentation 502 may include a listing of metadata of the instances of media content 306 of the playlist 310. As illustrated, the playlist presentation 502 includes titles of the instances of media content 306, play length of the instances of media content 306, ratings of the instances of media content 306, as well as a number indicating the relative placement of the media content 306 instance within the playlist 310. It should be noted, however, that more, fewer, or different items of metadata may be displayed in the playlist presentation 502. As one possibility, the playlist presentation 502 may allow for customization by the user of the nomadic device 53 to display or hide various elements of metadata information regarding the instances of media content 306. Regardless of the specifics being displayed, the playlist presentation 502 may in some examples include an indication 506 of the instance of media content 306 currently being played. As illustrated, the indication 506 illustrates that the third song is currently being played by the server nomadic device 53-A.

The add element 508 may be configured to cause the user interface 500 to present a listing of the registered media content list 308. The user interface 500 may be further configured to receive a selection of one or more instances of media content 306 from the registered media content list 308, as well as to add the selected instances of media content 306 to the playlist 310.

The playlist presentation 502 may be further configured to support user selection of one of more instances of media content 306 from the playlist presentation 502. The remove element 510 may be configured to cause the user interface 500 to remove the selected instances of media content 306 from the playlist 310. Similarly, the move up element 512 may be configured to move the selected instances of media content 306 upwards in the playlist 310, and the move down element 514 may be configured to move the selected instances of media content 306 downward in the playlist 310.

In some cases, the instances of media content 306 stored by a nomadic device 53 may change. For example, the nomadic device 53 may download additional instances of media content 306, or instances of media content 306 may be deleted from the nomadic device 53. The refresh element 516 may be configured to allow the nomadic device 53 to provide a refreshed listing of the instances of media content 306 on the device 53, to allow the server nomadic device 53-A to stay updated with current information. (In other examples, the nomadic device 53 may be configured to automatically provide updates to the server nomadic device 53-A regarding changes in media content 306, the server nomadic device 53-A may be configured to periodically poll the nomadic devices 53 for updates, etc.). If the server nomadic device 53-A determines that an instance of media content 306 on the playlist 310 has been removed from the nomadic device 53 on which it was stored, the server nomadic device 53-A may be configured to automatically remove that instance of media content 306 from the playlist 310 (or in some cases search the registered media content list 308 for another available copy of the removed instance).

When changes are made to the playlist 310, the nomadic device 53 displaying the user interface 500 may be configured to send a message to the server nomadic device 53-A configured to cause the server nomadic device 53-A to update the playlist 310. The server nomadic device 53-A may be further configured to inform the other nomadic devices 53 of the changes to the playlist 310, to allow the other nomadic devices 53 maintain updates playlist presentations 502. To allow for updating of the indication 506, the server nomadic device 53-A may also be configured to inform the nomadic devices 53 of which instance of media content 306 is currently being played, if any.

While the playlist presentation 502 is described above with respect to the nomadic devices 53, it should be noted that as illustrated in FIG. 3B, in some examples the head unit 302 may also operate as one of the devices 53 providing instances of media content 306, as well as optionally displaying and/or updating of the playlist 310. For example, instead of or in addition to the nomadic device 53-A connection to the VCS 1 via the media input 304, the VCS 1 may also be included in the local network allowing for sharing of the media playback functions of the VCS 1 among the nomadic devices 53. As one possibility, the head unit 302 may make available instances of media content 306 stored by a hard drive or other storage device of the VCS 1 for use by the server nomadic device 53-A. As another possibility, the head unit 302 of the VCS 1 itself may perform the role of the server nomadic device 53-A. As yet a further possibility, the head unit 302 of the VCS 1 may implement only a subset of the features of the nomadic devices 53, such as, for example, providing the playlist presentation 502 or only information regarding the currently played instance of media content 306 on a display of the head unit 302 for display purposes only, without offering editing capabilities to the shared playlist 310.

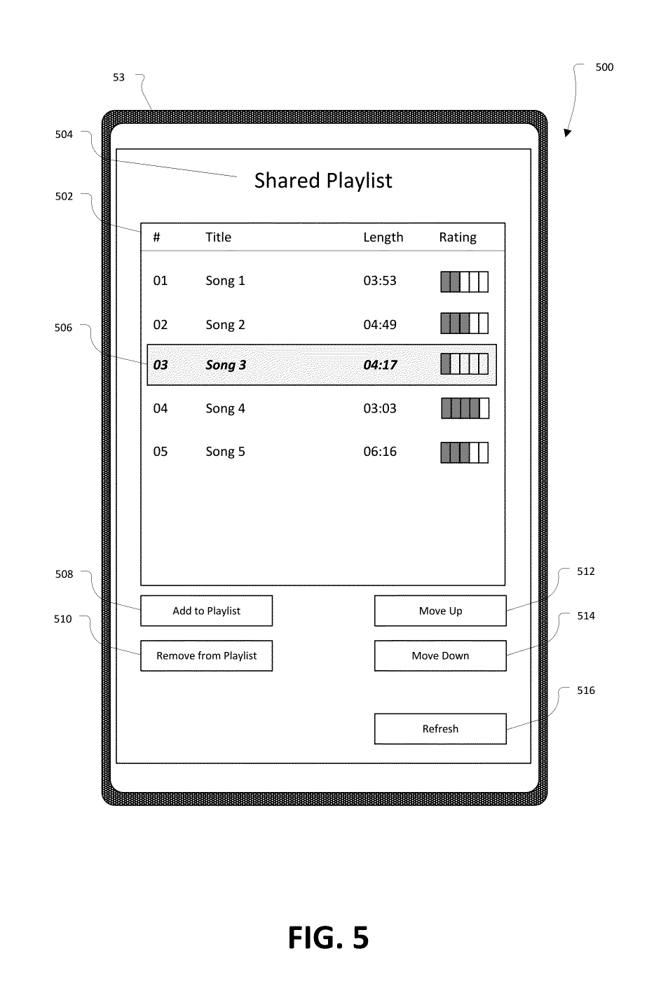

FIG. 6 illustrates an exemplary process 600 for compiling a combined registered media content list 308 of all the media content 306 stored by the nomadic devices 53. As one possibility, the process 600 may be implemented using software code contained within the nomadic devices 53. In other embodiments, the process 600 may be implemented in other controllers, or distributed amongst multiple vehicle 31 controllers such as the VCS 1 and/or the head unit 302 of the VCS 1.

At block 602, the server nomadic device 53-A provides a server address to other nomadic devices 53. As one example, the server nomadic device 53-A may be configured to display its address on a device display in a user-readable form such that users of other nomadic devices 53 may enter the displayed address into their devices 53. As another example, the server nomadic device 53-A may be configured to display its address encoded in a bar code or other device-recognizable format such that the other devices 53 may capture an image of the display of the server nomadic device 53-A and decode the image to retrieve the server address. As yet a further example, the server nomadic device 53-A may be configured to provide an audio encoding of the server address, such that the other devices 53 may capture and decode the audio to retrieve the server address.

At block 604, the server nomadic device 53-A identifies the other nomadic devices 53. For example, the devices 53 may send registration messages 402 to the identified address of the server nomadic device 53-A to register with the server nomadic device 53-A. The server nomadic device 53-A may accordingly identify the other nomadic devices 53 to be registered with the local network of devices 53.

At block 606, the server nomadic device 53-A requests media content 306 listings from the identified networked devices. As one possibility, the server nomadic device 53 may send a request 404 to each of the connected nomadic devices 53 querying the connected nomadic devices 53 for a listing of their instances of media content 306. Each identified device 53 being queried may be configured to compile and send a response 406 back to the server nomadic device 53-A including a listing of the instances of media content 306 hosted by the respective device. The listing may, for example, include the metadata for each of the instances of media content 306 hosted by the device.

At block 608, the server nomadic device 53-A receives the media content listings 306 from the identified networked devices. For example, the server nomadic device 53-A may receive the responses 406 back from the identified networked devices.

At block 610, the server nomadic device 53-A updates the registered media content list 308 according to the received media content listings 306. The server nomadic device 53 may be configured to compile a combined registered media content list 308 of all the media content 306 that the devices 53 each store locally. The registered media content list 308 may include, for example, a collection of the metadata media content 306 from the nomadic devices 53, as well as indications of which of the nomadic devices 53 store which instances of media content 306.

At decision point 612, the server nomadic device 53-A determines whether any media content 306 update have occurred. For example, the server nomadic device 53-A may receive an updated response 406 from a device 53 responsive to a user utilizing the refresh element 516 of the user interface 500. As another possibility, a nomadic device 53 may be configured to automatically notify the server nomadic device 53-A upon changes to the instances of media content 306 being made available. If the server nomadic device 53-A determines that media content 306 updates have occurred, control passes to block 610 to allow the server nomadic device 53-A to update the combined registered media content list 308. Otherwise control remains at decision point 612.

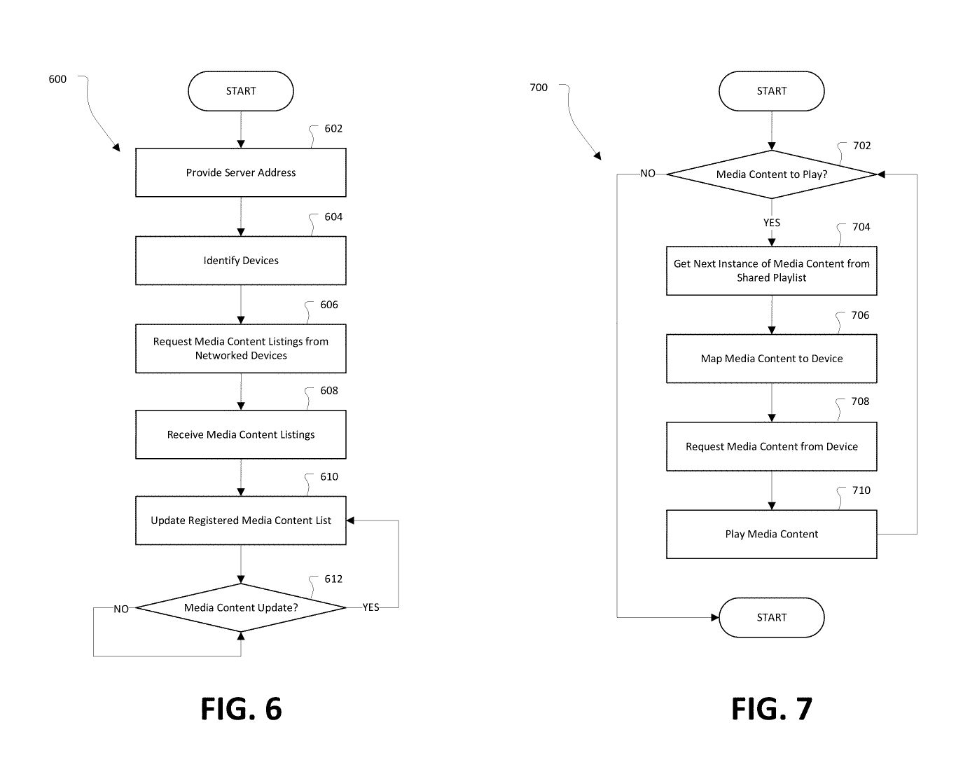

FIG. 7 illustrates an exemplary process 700 for playing media content 306 by the server nomadic device 53-A through the VCS 1. As with the process 600, the process 700 may be implemented using software code contained within the nomadic devices 53. In other embodiments, the process 700 may be implemented in other controllers, or distributed amongst multiple vehicle 31 controllers such as the VCS 1 and/or the head unit 302 of the VCS 1.

At decision point 702, the server nomadic device 53-A determines whether there is media content 306 to be played. For example, the server nomadic device 53-A may maintain a playlist 310 that may be edited by the nomadic devices 53 of the local network, and may determine whether any instances of media content 306 remain in the playlist 310 to be played. If so, control passes to block 704. Otherwise the process 700 ends.

At block 704, the server nomadic device 53-A gets the next instance of media content 306 specified by the playlist 310. For example, the server nomadic device 53-A may retrieve the metadata for the next item of media content 306 in the sequence of the playlist 310 to be played back.

At block 706, the server nomadic device 53-A maps the instance of media content 306 to a hosting device. For example, the server nomadic device 53-A may utilize the registered media content list 308 to determine which of the devices 53 stores the instance of media content 306 to be played back. As one possibility, the registered media content list 308 may include addresses of hosting or storing nomadic devices 53 for each instance of media content 306 included in the registered media content list 308. As another possibility, the registered media content list 308 may include identifiers of the storing nomadic devices 53, which may be translated by the server nomadic device 53-A into the address of the storing device 53.

At block 708, the server nomadic device 53-A requests the instance of media content 306 from the identified hosting device. For example, based on the identification of block 706, the server nomadic device 53-A may send a request 414 to the storing nomadic device 53-B requesting the instance of media content 306. The server nomadic device 53-A may be further configured to receive 416 the instance of media content 306 from the storing nomadic device 53-B being provided for playback.

At block 710, the server nomadic device 53-A plays the instance of media content 306. For example, the server nomadic device 53-A may be configured to process the media content 306 into an audio signal, and provide the audio signal from the server nomadic device 53-A to the media input 304 of the VCS 1. Additionally or alternately, the server nomadic device 53-A may be configured to process the media content 306 into a video signal, and provide the video signal from the server nomadic device 53-A to the media input 304 of the VCS 1. After block 710, control returns to decision point 702.

Variations on the system are possible. For example, rather than relying on the ordering of media content 306 in the shared playlist 310, the system may implement a shuffle mode to play media content 306 from the shared playlist 310 in a random order. As another possibility, the system may implement an extended shuffle mode configured to play random songs from the registered media content list 308, rather than from the shared playlist 310.

As a further extension, the system may implement a service to automatically generate entries for the playlist 310 through analysis and categorization of the media content 306 of the registered media content list 308 (e.g., by utilizing a service such as The Echo Nest of Somerville, Mass., through analysis of metadata of the media content 306 such as artist and genre, etc.). These categorizations of the media content 306 may be utilized by the system to include media content 306 in a shared playlist 310 that matches various genres, categories, tastes, or other categorizations of the registered media content list 308. For example, a user may request to listen to dance music, and the system may provide a playlist 310 including randomized dance music stored by the nomadic devices 53 of the system. Accordingly, the system may be able to generate custom playlists 310 tailored to the specific media content 306 and tastes of the users of the system (e.g., to the current vehicle occupants).

Referring again to FIGS. 6-7, the vehicle 31 and its components illustrated in FIGS. 1-5 are referenced throughout the discussion of the processes 600 and 700 to facilitate understanding of various aspects of the present disclosure. The processes 600 and 700 may be implemented through a computer algorithm, machine executable code, or software instructions programmed into a suitable programmable logic device(s) of the vehicle 31, such as the vehicle control module, the hybrid control module, another controller in communication with the vehicle computing system 1, or a combination thereof. Although the various steps shown in the process 600 and 700 appear to occur in a chronological sequence, at least some of the steps may occur in a different order, and some steps may be performed concurrently or not at all. Moreover, while the processes 600 and 700 are described in relation to nomadic devices 53, it should be noted that the head unit 202 may also be included as one of the nomadic devices 53, as discussed in detail above.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer-implemented method comprising:
compiling, by a server device, a combined media content list including metadata describing media content stored by network devices connected to the server device;
mapping, according to the content list, an instance of media content from a shared playlist maintained by the server device to one of the network devices storing the media content; and
playing the instance of media content through a server device media output to a playback system.

2. The method of claim 1, wherein the playback system includes a vehicle infotainment system.

3. The method of claim 1, further comprising:
providing an address of the server device to the network devices; and
receiving, from the network devices at the address of the server device, registration messages configured to register the network devices with the server device.

4. The method of claim 3, wherein providing the address includes at least one of (i) displaying an image on a display including the address to be captured by the network devices, (ii) playing an audio output including the address to be captured by the network devices, (iii) utilizing a local communication protocol to read information including the address made available by the server device, and (iv) utilizing network service discovery to look up the address according to an advertised media playback service registered by the server device.

5. The method of claim 1, further comprising:
sending a request to the network devices querying for instances of media content stored by the network devices; and
receiving, responsive to the request, listings of metadata describing the instances of media content stored by the network devices to be compiled into the combined media content list.

6. The method of claim 1, further comprising updating the shared playlist in accordance with a request from one of the network device to at least one of (i) add an instance of media content from the content list to the shared playlist, (ii) remove an instance of media content from the shared playlist, (iii) adjust an ordering of an instance of media content included in the shared playlist, and (iv) include instances of media content in the shared playlist that match a categorization of the metadata of the combined media content list.

7. A system comprising:
a vehicle infotainment system; and
a server configured to
compile a combined media content list of media stored by nomadic network devices wirelessly connected to the server via a local ad-hoc network;
retrieve a media content instance identified on a server-maintained shared playlist from one of the network devices identified by the content list as storing the media; and
provide the media content instance through a media output for infotainment system playback.

8. The system of claim 7, wherein the media output includes a wireless connection to the vehicle infotainment system.

9. The system of claim 8, wherein the server is included in a head unit of the vehicle infotainment system.

10. The system of claim 8, wherein the media output of the server is connected to an audio input to a vehicle infotainment system.

11. The system of claim 7, wherein the server is further configured to:
provide an address of the server to the network devices; and
receive, from the network devices at the address of the server, registration messages configured to register the network devices with the server.

12. The system of claim 11, wherein the server is further configured to provide the address by at least one of (i) display of an image including the address to be captured by the network devices, (ii) play of an audio output including the address to be captured by the network devices, (iii) utilize a local communication protocol to read information including the address made available by the server, and (iv) utilize network service discovery to look up the address according to an advertised media playback service registered by the server.

13. The system of claim 7, wherein the server is further configured to:
send a request to the network devices to cause the network devices to query for instances of media content stored by the network devices; and
receive, responsive to the request, listings of metadata that describe the instances of media content stored by the network devices to be compiled into the combined media content list.

14. The system of claim 7, wherein the server is further configured to update the shared playlist in accordance with a request from one of the network device to at least one of (i) add an instance of media content from the content list to the shared playlist, (ii) remove an instance of media content from the shared playlist, (iii) adjust an ordering of an instance of media content included in the shared playlist, and (iv) include instances of media content in the shared playlist that match a categorization of the combined media content list.

15. A non-transitory computer-readable medium comprising instructions configured to cause a server to:
compile a combined media content list of media stored by nomadic network devices wirelessly connected to the server via a local ad-hoc network;
retrieve a media content instance identified on a server-maintained shared playlist from one of the network devices identified by the content list as storing the media; and
provide the media content instance through a media output to a playback system.

16. The computer-readable medium of claim 15, wherein the playback system includes a vehicle infotainment system.

17. The computer-readable medium of claim 15, further comprising instructions configured to cause the server to:
provide an address of the server to the network devices; and
receive, from the network devices at the address of the server, registration messages configured to register the network devices with the server.

18. The computer-readable medium of claim 17, further comprising instructions configured to cause the server to provide the address by at least one of (i) display of an image including the address to be captured by the network devices, (ii) play of an audio output including the address to be captured by the network devices, (iii) utilize a local communication protocol to read information including the address made available by the server, and (iv) utilize network service discovery to look up the address according to an advertised media playback service registered by the server.

19. The computer-readable medium of claim 15, further comprising instructions configured to cause the server to:
send a request to the network devices to cause the network devices to query for instances of media content stored by the network devices; and
receive, responsive to the request, listings of metadata that describe the instances of media content stored by the network devices to be compiled into the combined media content list.

20. The computer-readable medium of claim 15, further comprising instructions configured to cause the server to update the shared playlist in accordance with a request from one of the network device to at least one of (i) add an instance of media content from the content list to the shared playlist, (ii) remove an instance of media content from the shared playlist, (iii) adjust an ordering of an instance of media content included in the shared playlist, and (iv) include instances of media content in the shared playlist that match a categorization of the combined media content list.
